(19) United States
(12) Patent Application Publication
(10) Pub. No.: US 2026/0204015 A1
(43) Pub. Date: Jul. 16, 2026

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventor: YOHEI SHIRAKI, Tokyo (JP)

(21) Appl. No.: 19/446,803

(22) Filed: Jan. 12, 2026

(30) Foreign Application Priority Data
Jan. 14, 2025 (JP) 2025-004656

(51) Int. Cl. G06T 17/00; G06T 7/70; G06V 10/25

(52) U.S. Cl. CPC G06T 17/00; G06T 7/70; G06V 10/25

(57) ABSTRACT

Viewing information representing an area of a three-dimensional model viewed by a viewer is acquired, an area of interest of the three-dimensional model of the viewer is calculated from the viewing information, a position and an orientation of an imaging apparatus imaging an imaging area determined on the basis of the area of interest are calculated, a device inputting information used for changing the position and the orientation of the imaging apparatus is controlled on the basis of the position and the orientation of the imaging apparatus that have been calculated, image data is acquired from the imaging apparatus, reduced data is generated by reducing a data amount of the image data or converted data acquired by converting the image data on the basis of the area of interest, and a three-dimensional model is generated using the reduced data.

### BACKGROUND

### Field of the Technology

The present disclosure relates to an information processing device, an information processing method, and a storage medium.

### DESCRIPTION OF THE RELATED ART

In recent years, technologies for generating a three-dimensional model by imaging a target object from multiple viewpoints using a camera and three-dimensionally reconstructing the multiple-viewpoint video have been proposed. Here, a free-viewpoint video content enabling a target object to be viewable from an arbitrary position/orientation by delivering a three-dimensional model to a head-mounted display for viewing can be provided.

In a technique disclosed in Japanese Patent No. 6702196, spatial areas with high degrees of attention are calculated by detecting line-of-sight information from an image in which spectators in a stadium are shown, and a free-viewpoint video is generated while being limited to the areas with high degrees of attention.

However, in the technique disclosed in Japanese Patent No. 6702196, the degree of attention of a user viewing a content, which is delivered via the Internet or the like, at a remote place in real time is not taken into account. Furthermore, in large venues such as stadiums, while it is possible to calculate large areas of interest, it is difficult to obtain detailed information about which areas are being focused on.

Accordingly, there is a problem in reducing the amount of processing at the time for generating a three-dimensional model. For example, in a stadium in which a sports event is taking place, the problem is that it is difficult to estimate which person in the stadium the attention is focused on. For this reason, there has been room for improvement in the reduction of the amount of data based on the user’s degree of attention for contents of a multiple-viewpoint video.

### SUMMARY

An information processing device according to one embodiment of the present disclosure acquires viewing information representing an area of a three-dimensional model viewed by a viewer, calculates an area of interest of the three-dimensional model of the viewer from the viewing information, calculates a position and an orientation of an imaging apparatus imaging an imaging area determined on the basis of the area of interest, controls a device inputting information used for changing the position and the orientation of the imaging apparatus on the basis of the position and the orientation of the imaging apparatus that have been calculated, acquires image data from the imaging apparatus, generates reduced data by reducing a data amount of the image data or converted data acquired by converting the image data on the basis of the area of interest, and generates a three-dimensional model using the reduced data.

Further features of the present disclosure will become apparent from the following description of embodiments with reference to the attached drawings.

### BRIEF DESCRIPTION OF THE DRAWINGS

FIG. 1 is an diagram illustrating a scene in which an information processing device of the present disclosure is illustrated.

FIG. 2 is a hardware configuration of the information processing device according to the embodiment of the present disclosure.

FIG. 3 is a logical block configuration diagram of the information processing device according to the embodiment of the present disclosure.

FIG. 4 is a flowchart illustrating a processing sequence performed by the information processing device according to the embodiment of the present disclosure when generating a three-dimensional model.

FIG. 5 is an diagram of an area of interest calculating process according to the embodiment of the present disclosure.

FIG. 6 is a flowchart illustrating a processing sequence of an area of interest calculating process according to the embodiment of the present disclosure.

FIG. 7 is an diagram illustrating a usage scene of an information processing device according to the present disclosure.

FIG. 8 is a flowchart illustrating a control sequence according to the second embodiment of the present disclosure.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### <First Embodiment>

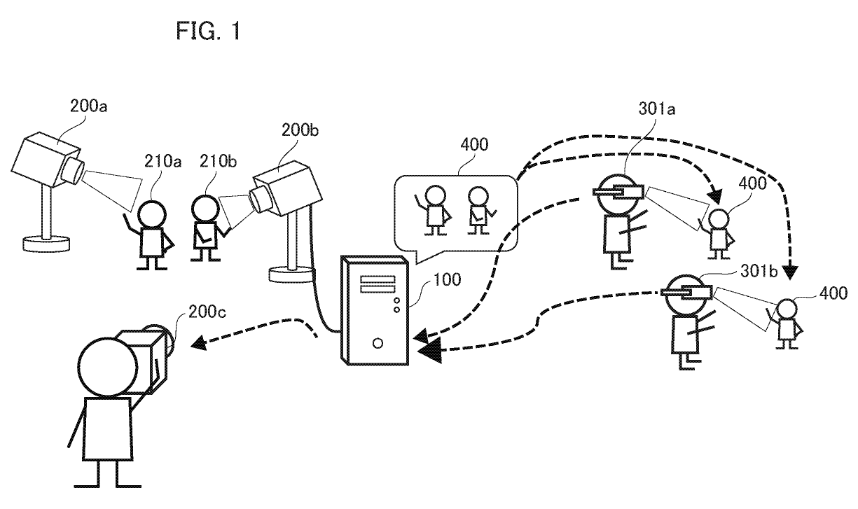

FIG. 1 is an image diagram illustrating a usage scene of an information processing device according to a embodiment of the present disclosure which is a usage scene of a three-dimensional reconstruction system using the information processing device. The information processing device 100 constitutes a three-dimensional reconstruction system that generates a three-dimensional model by imaging a performer on a stage such as a live house or a concert hall using a plurality of cameras and three-dimensionally reconstructing acquired images.

The three-dimensional model generated by the information processing device 100 is distributed in real time through the Internet. A viewer views the three-dimensional model that has been distributed in real time using a head-mounted display (HMD) of a head mounting type.

Each of an imaging apparatus 200a and an imaging apparatus 200b is a fixed camera of which the position and the orientation are fixed, and the position and the orientation thereof are known through in-advance calibration. Here, the position is a three-degree-of-freedom position in a three-dimensional space, and the orientation is a three-degree-of-freedom rotation in a three-dimensional space. In addition, a position/orientation represents six degrees of freedom combining a position and an orientation.

An imaging apparatus 200c is a movable camera that can be moved to an arbitrary position/orientation. The imaging apparatus 200c has a liquid crystal monitor in addition to components required for imaging mounted therein. An image capturer using the imaging apparatus 200c can check a video during imaging and the state of the imaging apparatus 200c by viewing the liquid crystal monitor.

Each of subjects 210a and 210b is a target to be three-dimensionally reconstructed and is imaged by the imaging apparatuses 200a to 200c. Hereinafter, when the imaging apparatuses 200a to 200c are to be described without distinction, they will be simply referred to as an imaging apparatus 200.

A three-dimensional model 400 is a model generated by the information processing device 100 and is a model that is represented three-dimensionally as a set of triangular mesh units. A texture image generated from images captured by the imaging apparatuses 200a to 200c is assigned to each triangular mesh unit.

An HMD 301a and an HMD 301b are devices that are used for viewing the three-dimensional model 400 and other videos. Hereinafter, when the HMD 301a and the HMD 301b are to be described without distinction, they will be simply referred to as an HMD 301.

The HMD 301 renders the three-dimensional model 400, which has been received via the Internet, into a stereoscopically viewable two-dimensional image through a rendering process and displays the two-dimensional image on a display in front of the viewer’s eyes. The HMD 301 is an example of the display device of the head-mounting type.

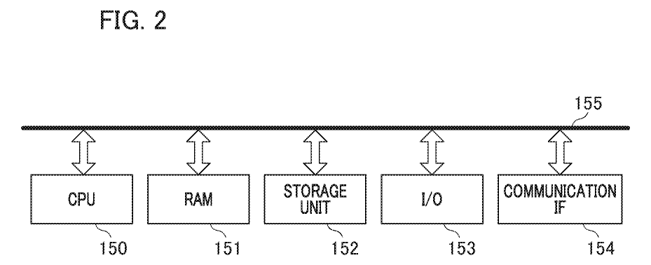

FIG. 2 is a hardware configuration diagram of the information processing device 100. The information processing device 100 is configured using a CPU 150, a RAM 151, a storage unit 152 such as an HDD or an SSD, an I/O 153, a communication IF 154, and a system bus 155.

The CPU is an abbreviation of a central processing unit. The RAM is an abbreviation of a random access memory. The HDD is an abbreviation of a hard disk drive. The SSD is an abbreviation of a solid state drive. The I/O is an abbreviation of an input/output. The IF is an abbreviation of an interface.

The CPU 150 executes an operating system (OS) and various computer programs stored in the storage unit 152 using the RAM 151 as a work memory and controls each unit through the system bus 155.

For example, programs executed by the CPU 150 include a program used for calculating the position/orientation of a camera that are appropriate when the three-dimensional model 400 is generated. The I/O 153 communicates with hardware connected to the information processing device 100.

The I/O 153, for example, controls the imaging apparatuses 200a to 200c and acquires image data output by the imaging apparatuses 200a to 200c. The communication IF 154 communicates with other hardware using wired communication or wireless communication. The communication IF 154, for example, communicates with the HMD 301a and the HMD 301b to transmit and receive information.

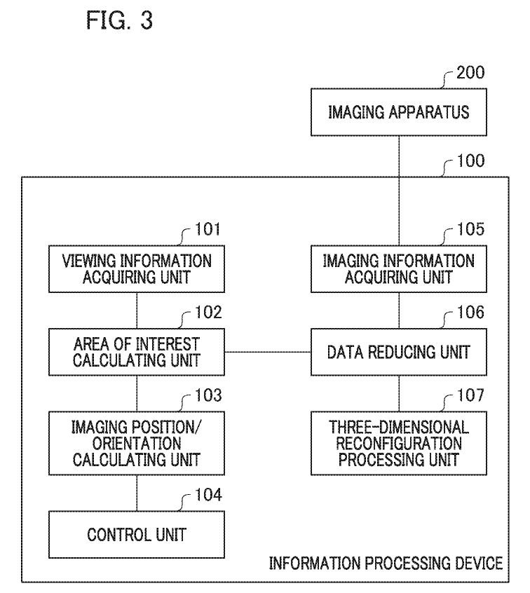

FIG. 3 is a logical block configuration diagram illustrating a logical configuration of the information processing device 100. A viewing information acquiring unit 101 acquires viewing information relating to the viewing of the three-dimensional model 400. The viewing information according to the present embodiment is the position/orientation of a virtual camera used in a rendering process of generating a stereoscopic image displayed on the display of the HMD 301 from the three-dimensional model 400.

An area of interest calculating unit 102 calculates an area of interest for which the degree of viewer’s interest is high on the basis of the viewing information acquired by the viewing information acquiring unit 101. An imaging position/orientation calculating unit 103 calculates position/orientation of the imaging apparatus 200c that are preferable for generating a higher-quality three-dimensional model 400 on the basis of the area of interest calculated by the area of interest calculating unit 102.

The imaging position/orientation calculating unit 103 is an example of an imaging position/orientation calculating means that calculates a position and an orientation of an imaging apparatus that images an imaging area determined on the basis of the area of interest.

A control unit 104 controls a device that inputs information used for changing the position/orientation of the imaging apparatus 200c on the basis of the position and the orientation calculated by the imaging position/orientation calculating unit 103. In the present embodiment, by superimposing arrows onto a video during imaging by controlling the display of the liquid crystal monitor of the imaging apparatus 200c, the position and the orientation of the imaging apparatus 200c that are preferable for imaging are instructed for an image capturer.

An imaging information acquiring unit 105 acquires imaging information from the imaging apparatuses 200a to 200c. Here, the imaging information includes image data. A data reducing unit 106 reduces the data amount of image data acquired from the imaging information acquiring unit 105 on the basis of area of interest information calculated by the area of interest calculating unit 102 and generates an image of which the amount of data has been reduced.

A three-dimensional reconstruction processing unit 107 performs three-dimensional reconstruction using the image data, of which the amount of data has been reduced, that has been acquired from the data reducing unit 106. The image data of which the amount of data has been reduced is an example of reduced data. The three-dimensional reconstruction processing unit 107 is an example of a three-dimensional model generating means that generates a three-dimensional model using reduced data.

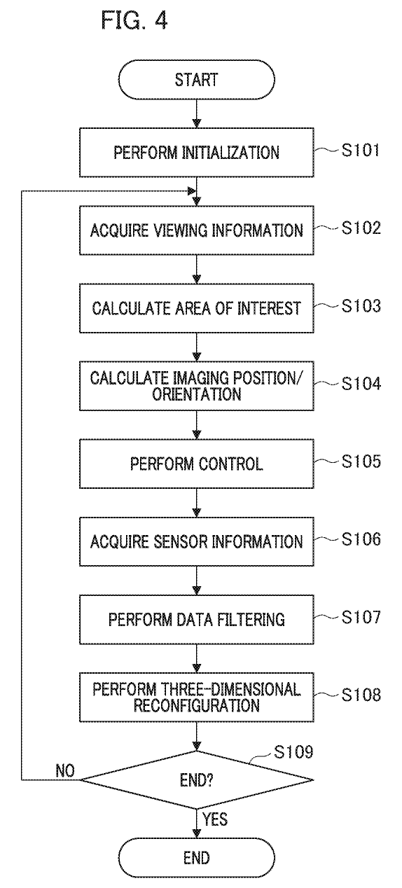

FIG. 4 is a flowchart illustrating the entire sequence of the process of the information processing device 100 generating a three-dimensional model 400. In Step S101, the information processing device 100 performs an initialization process, and thus a state in which the information processing device 100 can operate is formed.

In Step S102, the viewing information acquiring unit 101 acquires viewing information from the HMD 301 via the communication IF 154. Here, the viewing information includes information of a position/orientation of a virtual camera that are necessary for image rendering for displaying the three-dimensional model 400 on the display of the HMD 301.

In Step S103, the area of interest calculating unit 102 calculates an area of interest on the basis of the viewing information, which has been acquired from at least one HMD 301, that has been acquired by the viewing information acquiring unit 101. Here, in a case in which viewing information is acquired from a plurality of HMDs 301, an area of interest is calculated on the basis of viewing information of the plurality of HMDs 301. Details of the method of calculating an area of interest are described below.

In Step S104, the imaging position/orientation calculating unit 103 calculates the imaging position/orientation of the imaging apparatus 200c on the basis of the area of interest calculated by the area of interest calculating unit 102. Here, the imaging position/orientation of the imaging apparatus 200c calculated by the imaging position/orientation calculating unit 103 is a position/orientation at which an area of interest can be imaged with high image quality.

By enhancing the image quality of an image relating to an area of interest, the image quality of texture applied to a triangular mesh of the three-dimensional model 400 of the area of interest is improved. Furthermore, in the three-dimensional reconstruction described below, when distance measurement using stereo vision is performed from multiple viewpoints, the shorter a distance between the imaging apparatus 200c and subjects 210a and 210b, the more accurately the distance measurement can be performed.

For this reason, the accuracy of the three-dimensional reconstruction becomes high, and the shape quality of the three-dimensional model 400 is enhanced. On the other hand, when the imaging apparatus 200c gets too close to the subjects 210a and 210b, the area of interest does not fit within the image. Thus, the position/orientation of the imaging apparatus 200c to be calculated are assumed to be a position/orientation at which imaging can be performed as closely as possible while the area of interest fits within the image.

For example, in a case in which the degree of attention for the face of the subject 210a is high, a position/orientation of the imaging apparatus 200c at which the face of the subject 210a can be imaged at a relatively short distance are calculated. On the other hand, in a case in which the degree of attention for the whole body of the subject 210b is high, a position/orientation of the imaging apparatus 200c at which the front side and the whole body of the subject 210b can be imaged are calculated.

In Step S105, the control unit 104 controls the device on the basis of the imaging position/orientation calculated by the imaging position/orientation calculating unit 103. In the present embodiment, the control unit 104 controls the display of the liquid crystal monitor of the imaging apparatus 200c.

The control unit 104 displays arrows guiding an image capturer on the liquid crystal monitor while being superimposed onto a video such that the position/orientation calculated by the imaging position/orientation calculating unit 103 coincide with the position/orientation of the imaging apparatus 200c. By moving the imaging apparatus 200c according to the guidance of the liquid crystal monitor, the image capturer can capture a video that is appropriate for three-dimensional reconstruction.

In Step S106, the imaging information acquiring unit 105 acquires images from the imaging apparatuses 200a to 200c. In Step S107, the data reducing unit 106 reduces the data amount of image data captured by the imaging apparatuses 200a to 200c on the basis of the area of interest information calculated by the area of interest calculating unit 102.

For example, in a case in which the degree of attention for the face of the subject 210a is high, trimmed image data of which the data amount has been reduced is acquired by trimming image areas other than the face of the subject 210a and the vicinity thereof. By using the trimmed image as input for the three-dimensional reconstruction processing unit 107 to be described below, the amount of calculation relating to three-dimensional reconstruction can be reduced.

In Step S108, the three-dimensional reconstruction processing unit 107 performs three-dimensional reconstruction on the basis of the trimmed image data input from the data reducing unit 106 and the position/orientation information of the imaging apparatuses 200a to 200c. Hereinafter, a specific process performed by the three-dimensional reconstruction processing unit 107 in Step S108 is described.

The three-dimensional reconstruction processing unit 107, first, acquires the position/orientation of the imaging apparatus 200c using a visual odometry algorithm. The three-dimensional reconstruction processing unit 107 detects feature points from each trimmed image and performs feature point matching of detected feature points between images.

Next, the three-dimensional reconstruction processing unit 107 estimates the position/orientation of the imaging apparatus 200c on the basis of the position/orientation information of the imaging apparatus 200a and the imaging apparatus 200b that have been calibrated in advance and position information of the feature points that have been matched.

Next, the three-dimensional reconstruction processing unit 107 converts each image into a three-dimensional point cloud using the position/orientation information of the imaging apparatuses 200a to 200c. The three-dimensional reconstruction processing unit 107 performs rectification of each trimmed image using the position/orientation information of the imaging apparatuses 200a to 200c.

The three-dimensional reconstruction processing unit 107 converts the trimmed image that has been rectified into a parallax image by performing block matching of the trimmed image. The converted parallax image is converted into a three-dimensional point cloud on the basis of camera parameters such as a focal distance and a principal point of the camera that has been calibrated in advance.

Finally, the three-dimensional reconstruction processing unit 107 generates a three-dimensional model 400 from the three-dimensional point cloud by using a TSDF algorithm, which represents a three-dimensional space using voxels of 3D grids, and a marching cubes algorithm, which converts voxels into a mesh.

The TSDF is an abbreviation of a truncated signed distance function. The three-dimensional reconstruction processing unit 107 reconstructs a three-dimensional space from a three-dimensional point cloud using voxels by using the TSDF algorithm.

At this time, the three-dimensional point cloud input to the three-dimensional reconstruction processing unit 107 is generated from a trimmed image and thus has a small amount of data. Thus, the amount of calculation of the three-dimensional reconstruction process is suppressed. Thereafter, the three-dimensional reconstruction processing unit 107 applies the marching cubes algorithm to the voxels and generates a three-dimensional model 400 composed of triangular meshes.

In Step S109, the information processing device 100 judges whether or not the system is to be ended. In a case in which an end instruction is input by an input means (not illustrated), the information processing device 100 judges that the system is to be ended and ends the system.

In a case in which no end instruction has been input, the information processing device 100 judges that the system is not to be ended and returns the process to Step S102. Every time viewing information supplied from the HMD 301 and a stereo color image supplied from the imaging apparatus 200 are input, the information processing device 100 repeatedly performs the processes of Steps S102 to S108.

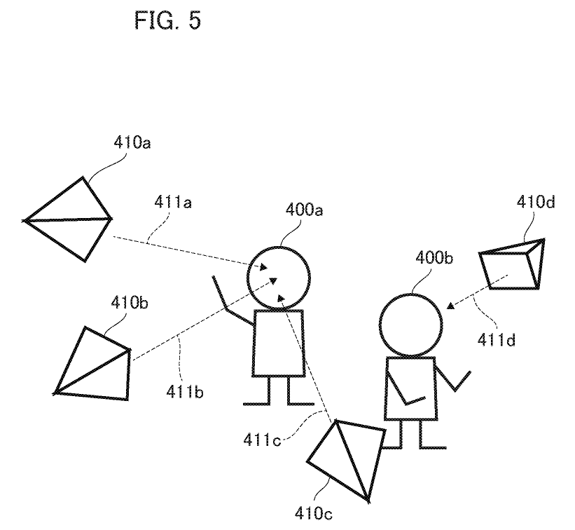

FIG. 5 is an image diagram of an area of interest calculating process of the area of interest calculating unit 102. An area of interest is calculated on the basis of the coordinates at which line-of-sight vectors 411a to 411d calculated from the virtual cameras 410a to 410d and the three-dimensional model 400 intersect with each other.

The virtual cameras 410a to 410d correspond to the position/orientation of the HMD 301 with reference to the three-dimensional model 400 distributed to the HMD 301. The HMD 301 converts the three-dimensional model 400 into a two-dimensional image that represents how the model appears from the virtual viewpoints from the positions and orientations of the virtual cameras 410a to 410d through rendering processing.

The HMD 301 displays the converted two-dimensional image on the display in front of the viewer’s eyes. The positions/orientations of the virtual cameras 410a to 410d can be changed in real time in accordance with a viewpoint change operation performed by a user of the HMD 301 and a viewer’s head movement or walking motion detected by the HMD 301. Hereafter, when the virtual cameras 410a to 410d are described without distinction, they will be simply referred to as a virtual camera 410.

The line-of-sight vectors 411a to 411d are vectors that represent line-of-sight information of a viewer wearing the HMD 301. The origins of the line-of-sight vectors 411a to 411d are the origins of the virtual cameras 410a to 410d, and directions of the line-of-sight vectors are the same as the orientations of the virtual cameras 410a to 410d.

The lengths of the line-of-sight vectors 411a to 411d are respective lengths from the origins of the line-of-sight vectors 411a to 411d to the surface of the three-dimensional model 400. Among triangular meshes constituting the three-dimensional model 400, triangular meshes intersecting with the line-of-sight vectors 411a to 411d and triangular meshes in the vicinity thereof are areas of which the degree of attention is high. Hereafter, when the line-of-sight vectors 411a to 411d are described without distinction, they are simply referred to as a line-of-sight vector 411.

A three-dimensional model 400a is a three-dimensional model corresponding to the subject 210a among three-dimensional models 400 generated by the three-dimensional reconstruction processing unit 107. A three-dimensional model 400b is a three-dimensional model corresponding to the subject 210b among three-dimensional models 400 generated by the three-dimensional reconstruction processing unit 107.

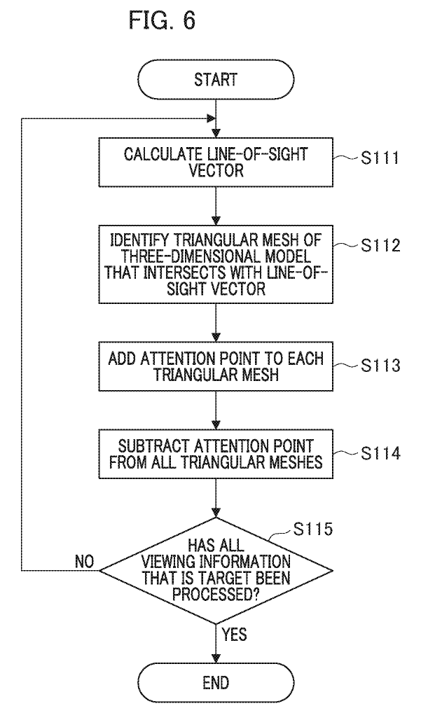

FIG. 6 is a flowchart illustrating a processing sequence of the area of interest calculating process of the area of interest calculating unit 102 and is a diagram illustrating the process of Step S103 represented in FIG. 4 in detail. In Step S111, the area of interest calculating unit 102 calculates each line-of-sight vector 411 on the basis of information received from the HMD 301.

In the present embodiment, the line-of-sight vector 411 is calculated on the basis of the position and the orientation of each virtual camera 410. A place at which many line-of-sight vectors 411 intersect with the three-dimensional model 400 is an area that is viewed by many viewers. In FIG. 5, the degree of attention on the face portion of the three-dimensional model 400a, that is, the subject 210a is high.

In Step S112, the area of interest calculating unit 102 identifies a triangular mesh that contains an intersection point between the line-of-sight vector 411 and the three-dimensional model 400. In Step S113, the area of interest calculating unit 102 adds attention points representing the degree of attention for each triangular mesh that is within a predetermined distance from the identified triangular mesh.

At this time, the higher values the attention points to be added have, the closer to the intersection point intersecting with the line-of-sight vector 411 they are. A triangular mesh of which an attention point is above a threshold is determined to be an area of interest.

In Step S114, the area of interest calculating unit 102 uniformly subtracts an attention point from all the triangular meshes. By performing uniform subtraction, the attention points decrease over time. In Step S115, the area of interest calculating unit 102 judges whether or not all the viewing information that is a target has been processed.

In a case in which the processing relating to all the viewing information has been completed, the process illustrated in FIG. 6 ends, and, in a case in which there is viewing information that has not been processed, the process is returned to Step S111, and the process continues. Here, all the viewing information does not need to be viewing information of all the viewers and may be viewing information acquired from HMDs 301 corresponding to a predetermined number that have been randomly selected.

According to the present embodiment, by collecting areas of interest and performing three-dimensional reconstruction while being limited to the areas of interest and calculating an imaging position/orientation to be recommended on the basis of the areas of interest, both the suppression of the amount of calculation and the generation of a high-quality model can be achieved.

In the embodiment, although the viewing information acquiring unit 101 acquires viewing information from the HMD 301, the configuration is not limited thereto. For example, instead of the HMD 301, a portable terminal such as a tablet terminal in which an application capable of viewing the three-dimensional model 400 is mounted may be used.

In the embodiment, although the area of interest calculating unit 102 calculates the areas of interest on the basis of the position/orientation of the virtual camera 410, the configuration is not limited thereto. For example, in a case in which a line-of-sight detecting device is mounted in the HMD 301, the area of interest may be calculated by combining the orientation information detected by the line-of-sight detecting device in addition to the information of the position and the orientation of the virtual camera 410. By using the line-of-sight detecting device, movements of only the eyeballs without movement of the head can be accurately tracked, and thus the area of interest can be calculated more accurately.

In addition, in the embodiment, although the area of interest is calculated using the line-of-sight vector 411, the configuration is not limited. For example, feature points extraction may be performed from a rendered image of each HMD 301, and the area of interest may be calculated on the basis of the number of matched feature points and the density thereof.

More specifically, first, feature points are extracted from each rendered image using a plurality of HMDs 301. Next, information of feature points is acquired from the plurality of HMDs 301, and matching is performed using the acquired feature points. Feature points that achieve a predetermined number or more of matches may be regarded as area of interest feature points, and an area in which a large number of such area of interest feature points are present may be calculated as an area of interest.

The area of interest calculating unit 102 may calculate the area of interest on the basis of the virtual viewpoint information at the time of the HMD 301 rendering an image from the three-dimensional model.

In addition, the area of interest may be calculated by inputting time-series rendered image information of the HMD 301 to a machine learning algorithm and performing segmentation.

In addition, priority assignment may be performed as another factor in the calculation of an area of interest. For example, areas of interest may be calculated by using information of users of HMDs 301 whose viewing time of the three-dimensional model 400 is long with priority, or areas of interest may be calculated using the information of users of HMDs 301 who have high payments with priority.

In the embodiment, although the imaging position/orientation calculating unit 103 calculates a position and an orientation at which the area of interest is shown as largely as possible in a video captured by the imaging apparatus 200, the configuration is not limited thereto. For example, what the area of interest is may be recognized using a machine learning algorithm, and the position and the orientation may be changed on the basis of a result of the recognition.

For example, in a case in which the area of interest is the entire body of a person, and it is recognized that the person is holding a musical instrument, a position and an orientation at which both the entire instrument and the body of the person are shown as largely as possible may be calculated. The imaging position/orientation calculating unit 103 may calculate a position and an orientation of the imaging apparatus 200 at which the proportion of the area of interest included in the image acquired by the imaging information acquiring unit 105 is large.

Furthermore, in addition to the position and the orientation, other parameters relating to the imaging apparatus such as a zoom ratio, a shutter speed, and ISO sensitivity may also be calculated.

In the embodiment, although the control unit 104 has been described to perform control such that arrows are displayed to be superimposed on a video of the liquid crystal monitor of the imaging apparatus 200c, the configuration is not limited thereto. For example, control may be performed such that the area of interest is overlaid in red, a frame is displayed, or the like.

Furthermore, the control target is not limited to the imaging apparatus 200c. For example, a dedicated display device may be controlled, or an image capturer may be guided using an artificial voice by controlling an audio output device.

In the embodiment, although the data reducing unit 106 reduces the data amount by trimming the image, the configuration is not limited thereto. For example, data reduction may be achieved by changing the frequency at which image data is input to the three-dimensional reconstruction processing unit 107.

More specifically, while all the videos in which the area of interest is shown large are input to the three-dimensional reconstruction processing unit, videos in which the area of interest is not shown or shown small are thinned out by inputting one image out of every four images, whereby the data is reduced.

Furthermore, the image data is converted into a three-dimensional point cloud using a plurality of pieces of image data and the position/orientation of the imaging apparatus 200, and the data amount of the three-dimensional point cloud may be reduced on the basis of the three-dimensional coordinates. For example, in a case in which the face of a person is an area of interest, data other than the three-dimensional point cloud near the three-dimensional coordinates at which the face of this person is present may be removed.

The three-dimensional point cloud is an example of converted data acquired by converting image data. The data reducing unit 106 may reduce the amount of data of the image data or the converted data acquired by converting the image data on the basis of the area of interest to generate reduced data.

The reduced data is data in which the data amount has been reduced by the data reducing unit 106. The data reducing unit 106 may reduce the data amount of either the image data or the three-dimensional point cloud or a plurality of data amounts.

In the embodiment, although the three-dimensional reconstruction processing unit 107 performs three-dimensional reconstruction after calculating the position/orientation of the imaging apparatus 200c on the basis of trimmed images, the configuration is not limited thereto. After images that have not been trimmed are used in the position/orientation estimation of the imaging apparatus 200c, trimmed images may be used only in the three-dimensional reconstruction process.

### <Second Embodiment>

In the above embodiment, the control unit 104 controls the liquid crystal monitor of the imaging apparatus 200c, and the position/orientation of the imaging apparatus 200c is manually changed by an image capturer who viewed the liquid crystal monitor. In the present embodiment, a method in which, by controlling a drone in which an imaging apparatus is mounted, a video that is appropriate for three-dimensional reconstruction can be automatically captured is described. In a second embodiment, an imaging apparatus 200d is included in place of the imaging apparatus 200c according to the above embodiment.

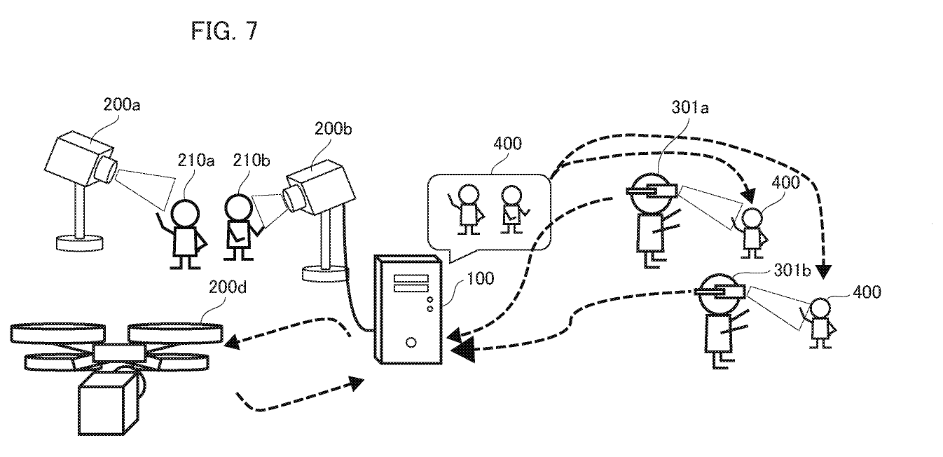

FIG. 7 is an image diagram illustrating a usage scene of an information processing device according to the second embodiment of the present disclosure. The imaging apparatus 200d according to the second embodiment is a remotely controllable drone and a full-color image camera mounted in a drone.

The imaging apparatus 200d transmits a captured video to the information processing device 100 via wireless communication. The information processing device 100 according to the second embodiment controls the position and the orientation of the imaging apparatus 200d. In description of the second embodiment, the same reference numerals are used for configurations that are the same as those according to the above embodiment, and a description thereof is omitted, and differences from the above embodiment are described below.

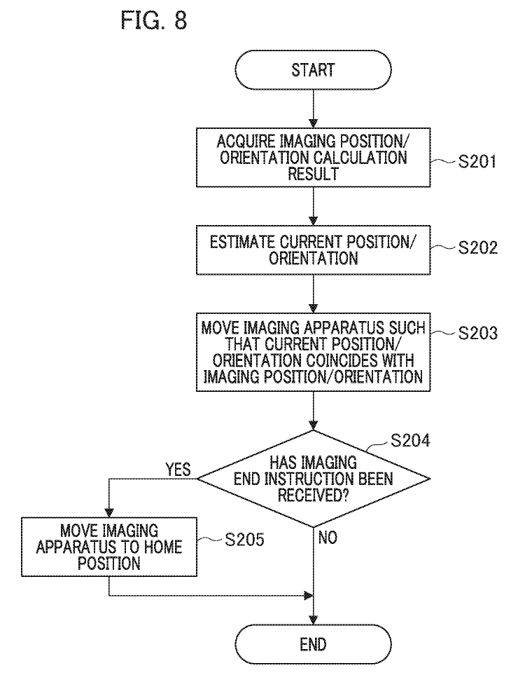

FIG. 8 is a flowchart illustrating a control sequence according to the second embodiment of the present disclosure. FIG. 8 is a flowchart illustrating a control sequence performed when a control unit 104 of the information processing device 100 according to the second embodiment controls the imaging apparatus 200d and is a diagram illustrating the process of Step S105 represented in FIG. 4 in the second embodiment in detail.

In Step S201, the control unit 104 acquires an imaging position/orientation calculation result calculated by the imaging position/orientation calculating unit 103.

In Step S202, the control unit 104 estimates the position and the orientation of the current imaging apparatus 200d. In the estimation of the position and the orientation, a visual odometry algorithm is used. First, the control unit 104 detects feature points from images of the imaging apparatus 200a, the imaging apparatus 200b, and the imaging apparatus 200d and performs matching of each feature point between images by using feature point descriptors of the detected feature points.

Next, the three-dimensional reconstruction processing unit 107 estimates the position/orientation of the imaging apparatus 200d on the basis of information of feature point pairs matched with the position/orientation information of the imaging apparatus 200a and the imaging apparatus 200b that have been calibrated in advance.

In Step S203, the control unit 104 performs control of a drone that is the imaging apparatus 200d such that the imaging position/orientation calculation result acquired in Step S201 and the current position/orientation of the imaging apparatus 200d estimated in Step S202 coincide with each other.

In Step S204, the control unit 104 judges whether or not an imaging end instruction has been received. In a case in which the control unit 104 judges that the imaging end instruction has been received, the process of Step S205 is executed, and in a case in which it is judged that the imaging end instruction has not been received, the process illustrated in FIG. 8 ends.

In Step S205, the control unit 104 performs control such that the drone that is the imaging apparatus 200d moves to a home position set in advance.

According to the present embodiment, by collecting areas of interest and performing three-dimensional reconstruction while being limited to the areas of interest, the amount of calculation is suppressed, and images required for generating a high-quality three-dimensional model can be automatically acquired.

In the second embodiment, although the control unit 104 controls the position and the orientation of the imaging apparatus 200d that is a drone, the configuration is not limited thereto. For example, the imaging apparatus that is a control target may be a camera crane or a network camera that can be controlled via a network.

The number of control targets of the control unit 104 does not need to be one, and a plurality of control targets may be controlled. In addition, a plurality of devices may be combined. For example, both the camera crane and the network camera may be controlled.

At this time, the same area of interest may be controlled to be imaged at multiple angles, and a plurality of areas of interest may be controlled to be respectively imaged. Furthermore, the control unit 104 does not need to directly control each device and may transmit a control instruction to a controller that centrally controls each device.

In the first and second embodiments, although the information processing device 100 has been described as a computer installed in a filming studio or the like, the configuration is not limited thereto. A configuration in which only a computer for camera control is installed in a filming studio, and the information processing device 100 is built on a cloud server and is connected via the Internet may instead be employed.

In the first and second embodiments, although the imaging apparatus 200 has been described as a monocular camera that captures color images, the configuration is not limited thereto. For example, the imaging apparatus 200 may be a stereo camera capable of stereoscopic imaging or a combination of a plurality of different types of cameras. Furthermore, a Light Detection and Ranging (LiDAR) sensor may be used in combination.

In the first and second embodiments, although a visual odometry algorithm is used in the position/orientation estimation of the imaging apparatus 200c and the imaging apparatus 200d, the configuration is not limited thereto. For example, the positions and the orientations of the imaging apparatuses 200c and 200d may be acquired using a visual simultaneous localization and mapping algorithm.

In addition, in the first and second embodiments, although the three-dimensional reconstruction processing unit 107 performs three-dimensional reconstruction using the TSDF algorithm, the configuration is not limited thereto. For example, three-dimensional reconstruction may be performed using an algorithm called Gaussian splatting.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the information processing device or the like through a network or various storage media. Then, a computer (or a CPU, an MPU, or the like) of the information processing device or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-004656, filed on January 14, 2025, which is hereby incorporated by reference herein in its entirety.

What is claimed is:

1. An information processing device comprising: at least one processor; and a memory storing instructions that, when executed by the at least one processor, cause the at least one processor to: acquire viewing information representing an area of a three-dimensional model viewed by a viewer; calculate an area of interest within the three-dimensional model of the viewer from the viewing information; calculate, based on the calculated area of interest, a position and an orientation of an imaging apparatus imaging an imaging area; control a device inputting information used to change the position and the orientation of the imaging apparatus based on the calculated position and the calculated orientation of the imaging apparatus; acquire image data from the imaging apparatus; generate reduced data by reducing a data amount of the image data or converted data acquired by converting the image data on the basis of the area of interest; and generate a three-dimensional model using the reduced data.

2. The information processing device according to claim 1, wherein, in the calculation of the area of interest, the area of interest is calculated based on information acquired from a head-mounting-type display device.

3. The information processing device according to claim 1, wherein, in the control, an instruction relating to change of the position and the orientation of the imaging apparatus is given based on the position and the orientation that have been calculated.

4. The information processing device according to claim 1, wherein, in the control, the imaging apparatus is controlled on the basis of the position and the orientation.

5. The information processing device according to claim 1, wherein, in the reduction of data, a data amount of either image data or three-dimensional point cloud data or a plurality of data amounts are reduced.

6. The information processing device according to claim 2, wherein, in the calculation of the area of interest, the area of interest is calculated based on virtual viewpoint information acquired at the time of the head-mounting-type display device rendering an image from a three-dimensional model.

7. The information processing device according to claim 1, wherein, in the calculation of the imaging position and orientation, a position and an orientation of the imaging apparatus at which a proportion of the area of interest included in the image data is high are calculated.

8. An information processing method comprising: acquiring viewing information representing an area of a three-dimensional model viewed by a viewer; calculating an area of interest within the three-dimensional model of the viewer from the viewing information calculating, based on the calculated area of interest, a position and an orientation of an imaging apparatus imaging an imaging area controlling a device inputting information used to change the position and the orientation of the imaging apparatus based on the calculated position and the calculated orientation of the imaging apparatus ;acquiring image data from the imaging apparatus ;generating reduced data by reducing a data amount of the image data or converted data acquired by converting the image data on the basis of the area of interest; and generating a three-dimensional model using the reduced data.

9. A non-transitory computer-readable storage medium storing a computer program including instructions, that when executed by at least one processor of an information processing device, cause the information processing device to execute the following processes: acquiring viewing information representing an area of a three-dimensional model viewed by a viewer; calculating an area of interest within the three-dimensional model of the viewer from the viewing information; calculating, based on the calculated area of interest, a position and an orientation of an imaging apparatus imaging an imaging area ;controlling a device inputting information used to change the position and the orientation of the imaging apparatus based on the calculated position and the calculated orientation of the imaging apparatus ; acquiring image data from the imaging apparatus;generating reduced data by reducing a data amount of the image data or converted data acquired by converting the image data on the basis of the area of interest; and generating a three-dimensional model using the reduced data.
